(19) United States
(12) Patent Application Publication
(10) Pub. No.: US 2025/0314511 A1
(43) Pub. Date: Oct. 9, 2025

(54) INTEGRATED ENCLOSURE FOR ULTRASONIC FLOWMETER

(71) Applicant: MICRO MOTION, INC., Boulder, CO (US)

(72) Inventor: Mohamed ZARKAN, Kallo (BE)

(73) Assignee: MICRO MOTION, INC., Boulder, CO (US)

(21) Appl. No.: 19/242,588

(22) Filed: Jun. 18, 2025

Related U.S. Application Data
(63) Continuation of application No. 17/939,584, filed on Sep. 7, 2022.

(51) Int. Cl. G01F 1/66; G01F 1/667

(52) U.S. Cl. CPC G01F 1/662; G01F 1/66; G01F 1/667

(57) ABSTRACT

A sonic- or ultrasonic flowmeter (200) is disclosed, comprising a body (202) with a machined cylindrically hollow bore configured to be connected to a pipeline, allowing fluid flow through the bore. The body (202) includes a first connector (204) at a first end (206) and a second connector (208) at a second end (210). The flowmeter (200) features meter electronics (220) with an interface section (222) and an acquisition section (224). The meter electronics (220) interface with sensors (235) to determine the degree of fluid flow through the pipeline based on signals from the sensors (235). The acquisition module (234) of the acquisition section (224) communicates with the sensors (235) and is mounted in a recess formed in an external flat region of the body (202). An enclosure form (236) is directly and sealedly attached to the body (202), circumscribing the acquisition module (234). The interface electronics (232) of the interface section (222) are housed in an upper enclosure (226), which is coupled to the enclosure form (236).

### CROSS-REFERENCE TO RELATED APPLICATIONS

This application is a continuation of U.S. patent application Ser. No. 17/939,584, filed on Sep. 7, 2022, the entire contents of which are incorporated herein by reference.

### TECHNICAL FIELD

The embodiments described below relate to ultrasonic flowmeters and, more particularly, to an integrated enclosure therefor.

### BACKGROUND

The measurement of the flow of a medium flowing through a measuring tube using an ultrasonic flowmeter is well-known in the prior art. Ultrasonic flowmeters generally comprise a measuring conduit and a plurality of ultrasonic transmitters/receivers that are disposed in the measuring conduit to measure fluid flow therethrough. An ultrasonic signal is generally emitted between a pair of ultrasonic transducers. The transit time of the signals between transducer pairs that are aimed with the fluid flow will be different from the transit time of signals measured against the flow. The flow velocity may be determined from this difference.

U.S. Pat. No. 9,528,866 B2, U.S. Pat. No. 7,810,399 B2, and U.S. Pat. Application No. 2015/0160052A1 disclose various arrangements for ultrasonic flowmeter transducers.

Ultrasonic meters are commonly used for custody transfer and fiscal oil and gas measurement. They measure the velocity of a fluid in a closed pipe and utilize transducers to emit ultrasonic pulses (greater than 20 KHz frequency) from which the flow meter can calculate the average velocity along the path of the beam of ultrasound. The fundamentals of ultrasonic meters make them suitable for gas or liquid measurement. Depending on the design, they use either wetted or non-wetted transducers on the pipe perimeter to couple ultrasonic energy with the fluid in the pipe.

Some ultrasonic flowmeters may operate using the Doppler Effect. In such meters, the signal frequency is altered by being reflected from particles and/or bubbles in the fluid.

The shift in frequency is proportional to the material flow rate passing thought the sensor. Other flowmeters may measure the difference in transit time between sonic or ultrasonic signals, as already noted.

Existing ultrasonic flow meter designs typically utilize two enclosures to house all the electronics. This is illustrated in prior art FIGS. 1 and 2. The upper enclosure 100 is generally a flameproof enclosure that houses the main CPU module, power supply, and customer I/O points. The lower base enclosure 102 is an intrinsically safe base enclosure that houses the acquisition module electronics for interfacing to the ultrasonic transducer sensors. The lower base enclosures are generally castings.

The present invention improves upon the design concept of the prior art lower base enclosure 102. In present embodiments, the acquisition module electronics are directly mounted to the top of the meter body. This provides a design for the electronics enclosure that is simple to fabricate and results in significant cost savings over existing meter designs.

### SUMMARY

A sonic- or ultrasonic flowmeter is provided according to an embodiment. The sonic- or ultrasonic flowmeter comprises a body configured to be connected to a pipeline and a first connector located on a first end of said body and a second connector located on a second end of said body. Meter electronics is configured to interface with sensors and to indicate the degree of fluid flow through the pipeline to which the flowmeter is connected based on signals received from the sensors, wherein the meter electronics comprises an acquisition section and an interface section. An acquisition module of the acquisition section is configured to communicate with the sensors. An attachment region is defined by the body, with the acquisition section being attached thereto. An enclosure form is sealedly attached to the body that circumscribes the acquisition module. Interface electronics of the interface section is housed in an upper enclosure, wherein the upper enclosure is coupled to the enclosure form.

A method for assembling a sonic- or ultrasonic flowmeter is provided according to an embodiment. The method comprises providing a body configured to be connected to a pipeline and attaching a first connector located on a first end of said body and attaching a second connector located on a second end of said body. Meter electronics is interfaced with sensors. The meter electronics indicates the degree of fluid flow through the pipeline to which the flowmeter is connected based on signals received from the sensors, wherein the meter electronics comprises an acquisition section and an interface section, and wherein an acquisition module of the acquisition section is configured to communicate with the sensors. An attachment region is defined by the body, with the acquisition section being attached thereto. An enclosure form is sealedly attached to the body that circumscribes the acquisition module. Interface electronics of the interface section is housed in an upper enclosure, wherein the upper enclosure is coupled to the enclosure form.

### Aspects

According to an aspect, a sonic- or ultrasonic flowmeter comprises a body configured to be connected to a pipeline and a first connector located on a first end of said body and a second connector located on a second end of said body. Meter electronics is configured to interface with sensors and to indicate the degree of fluid flow through the pipeline to which the flowmeter is connected based on signals received from the sensors, wherein the meter electronics comprises an acquisition section and an interface section. An acquisition module of the acquisition section is configured to communicate with the sensors. An attachment region is defined by the body, with the acquisition section being attached thereto. An enclosure form is sealedly attached to the body that circumscribes the acquisition module. Interface electronics of the interface section is housed in an upper enclosure, wherein the upper enclosure is coupled to the enclosure form.

Preferably, the attachment region comprises a cavity.

Preferably, a form cover is coupled to the enclosure form and provides a seal to the acquisition section from the outside environment.

Preferably, the form cover defines a mounting location for the upper enclosure.

Preferably, the upper enclosure comprises a display.

Preferably, a shroud that encases the acquisition section is attached to the body of the flowmeter.

Preferably, the enclosure form comprises at least one hole, and wherein a cable gland is installed in the at least one hole.

According to an aspect, a method for assembling a sonic- or ultrasonic flowmeter comprises providing a body configured to be connected to a pipeline and attaching a first connector located on a first end of said body and attaching a second connector located on a second end of said body. Meter electronics is interfaced with sensors. The meter electronics indicates the degree of fluid flow through the pipeline to which the flowmeter is connected based on signals received from the sensors, wherein the meter electronics comprises an acquisition section and an interface section, and wherein an acquisition module of the acquisition section is configured to communicate with the sensors. An attachment region is defined by the body, with the acquisition section being attached thereto. An enclosure form is sealedly attached to the body that circumscribes the acquisition module. Interface electronics of the interface section is housed in an upper enclosure, wherein the upper enclosure is coupled to the enclosure form.

Preferably, the method comprises the step of defining a cavity with the attachment region.

Preferably, the method comprises the steps of coupling a form cover to the enclosure form and sealing the acquisition section from the outside environment.

Preferably, the method comprises the step of defining a mounting location for the upper enclosure with the form cover.

Preferably, the upper enclosure comprises a display.

Preferably, the method comprises the step of attaching a shroud to the body and encasing the acquisition section with the shroud.

Preferably, the enclosure form comprises at least one hole, and a cable gland is installed in the at least one hole.

### BRIEF DESCRIPTION OF THE DRAWINGS

The same reference number represents the same element on all drawings. It should be understood that the drawings are not necessarily to scale.

FIG. 1 shows a prior art ultrasonic meter;

FIG. 2 shows another prior art ultrasonic meter;

FIG. 3 shows an ultrasonic meter according to an embodiment;

FIG. 4 shows the ultrasonic meter of FIG. 3 in a partially assembled state;

FIG. 5 shows the ultrasonic meter of FIG. 3 in another partially assembled state;

FIG. 6 illustrates an enclosure form; and

FIG. 7 shows the ultrasonic meter of FIG. 3 in yet another partially assembled state.

### DETAILED DESCRIPTION

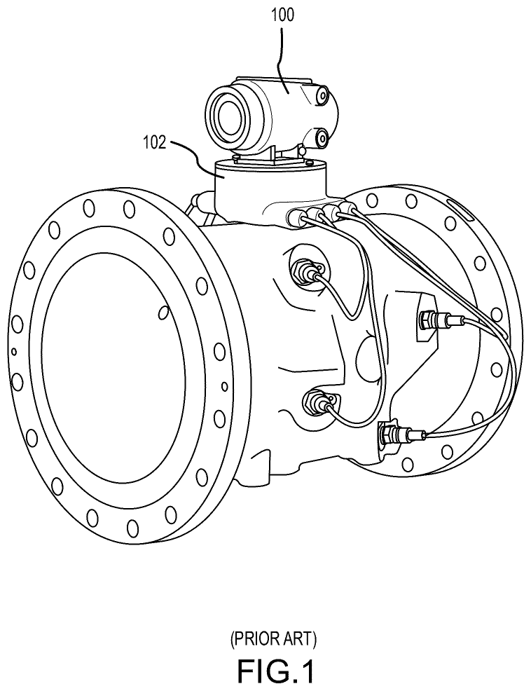

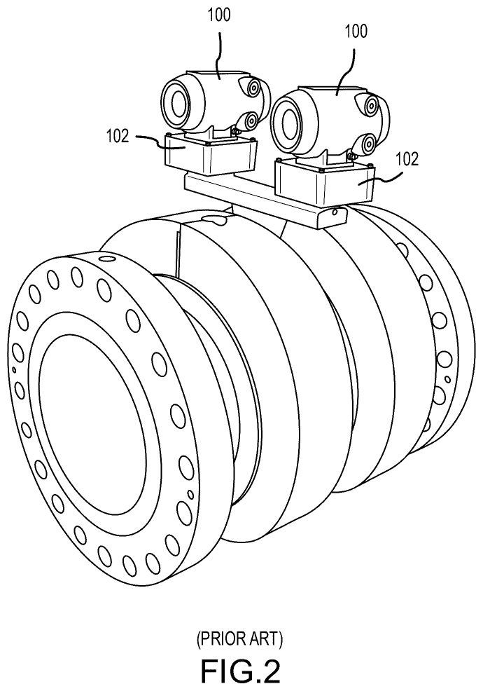

FIGS. 1-7 and the following description depict specific examples to teach those skilled in the art how to make and use the best mode of embodiments of a sonic or ultrasonic flowmeter. For the purpose of teaching inventive principles, some conventional aspects have been simplified or omitted. Those skilled in the art will appreciate variations from these examples that fall within the scope of the present description. Those skilled in the art will appreciate that the features described below can be combined in various ways to form multiple variations of embodiments. As a result, the embodiments described below are not limited to the specific examples described below, but only by the claims and their equivalents.

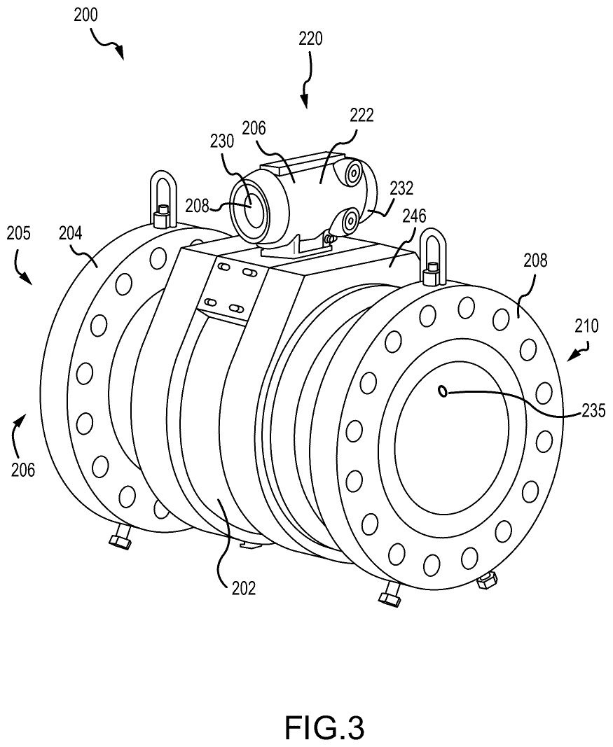

FIGS. 3-5 and 7 shows an ultrasonic flowmeter 200 according to an embodiment. The ultrasonic flowmeter 200 comprises a body 202 configured to be connected to a pipeline (not shown). The body 202 comprises a first connector 204 located on a first end 206 of the body 202 and a second connector 208 located on a second end 210 of the body 202. In the embodiment shown, the connectors 204, 208 are illustrated as flanges. It should be understood that other connections known in the art are also contemplated. Although the flowmeter is referred to as ultrasonic, the embodiments also contemplate a sonic flowmeter.

The connectors 204, 208 are affixed to the body 202 or are integral to the body 202. The body 202 defines the spacing between the connectors 204, 208. When the ultrasonic flowmeter 200 is inserted into a pipeline (not shown) which carries the process fluid being measured, the process fluid enters the ultrasonic flowmeter 200 through a first end 206, passes through the body 202 where the total amount of process fluid is directed to exit the ultrasonic flowmeter 200 through a second end 210.

The process fluid can comprise a liquid. The process fluid can comprise a gas. The process fluid can comprise a multi-phase fluid, such as a liquid including entrained gases and/or entrained solids, for example without limitation.

The body 202 houses at least one ultrasonic transducer (not shown) for transmission and/or reception of ultrasonic signals. Such transducers transmit an ultrasonic signal (or sonic signal) that is generally received by an opposing transducer. The transducers comprise transducers that are well-known in the art—for example, piezoelectric transducers.

The flowmeter 200 comprises a meter electronics 220, for providing measurement signals that indicate the degree of fluid flow through the pipe to which the flowmeter is connected. The measurement signals are based on signals received by the transducers. It should be understood that the meter electronics 220 can be comprised of various combinations of integrated and/or discrete components.

In the embodiments of the present invention, meter electronics 220 is divided into two primary sections: 1) the interface section 222; and 2) the acquisition section 224.

The interface section 222 comprises an upper enclosure 226 and interface electronics 232. The interface electronics 232 may comprise a display 230 and interface electronics 232 so that the meter electronics may send and receive signals to other electronics devices. The interface section 222 provides an input and an output means that allows the meter electronics 220 to interface with an operator. The interface electronics 232 may comprise one or more of physical connections and wireless communications means.

In operation, the ultrasonic flowmeter 200 provides various measurement values that may be outputted including one or more of a measured or averaged value of flow direction, flow rate, temperature, pressure, turbulence, swirl, symmetry, cross-flow, and any other measurements known in the art. The values can be monitored, recorded, saved, totaled, and/or output.

The meter electronics 220 may include interface electronics 232, a processing system, the acquisition module 234, and a storage system in communication with the processing system. It should be understood that the meter electronics 220 can be comprised of various combinations of integrated and/or discrete components. The processing system can comprise any manner of processing system. The processing system is configured to retrieve and execute stored routines in order to operate the ultrasonic flowmeter 200. The storage system can store instructions, routines, measurements, received values, working values, constants and other information.

The acquisition section 224 comprises an acquisition module 234. The acquisition module 234 comprises electronics that further comprise a transducer interface, and be inclusive of or communicate with the processing system and storage system. In embodiments, the acquisition module 234 is directly mounted to the meter body 202. In an embodiment, the acquisition module 234 is mounted into a machined recess 239 on the top of the meter body 202. Mounting is typically accomplished with mechanical fasteners.

Measurements taken and/or received by the acquisition module 234 can comprise a substantially instantaneous value, can comprise a sample, can comprise an averaged value over a time interval, or can comprise an accumulated value over a time interval. The time interval may be chosen to correspond to a block of time during which certain fluid conditions are detected, for example a liquid-only fluid state, or alternatively, a fluid state including liquids and entrained gas. In addition, other flow and related quantifications are contemplated and are within the scope of the description and claims.

The acquisition module 234 is configured to communicate with sensors 235 of the ultrasonic flowmeter 200. The acquisition module 234 may be configured to couple to leads (not shown in embodiments but exemplified in prior art FIG. 1) and exchange signals with the sensors, for example. The interface electronics 232 may be further configured to communicate with external devices using a physical connection and/or wirelessly.

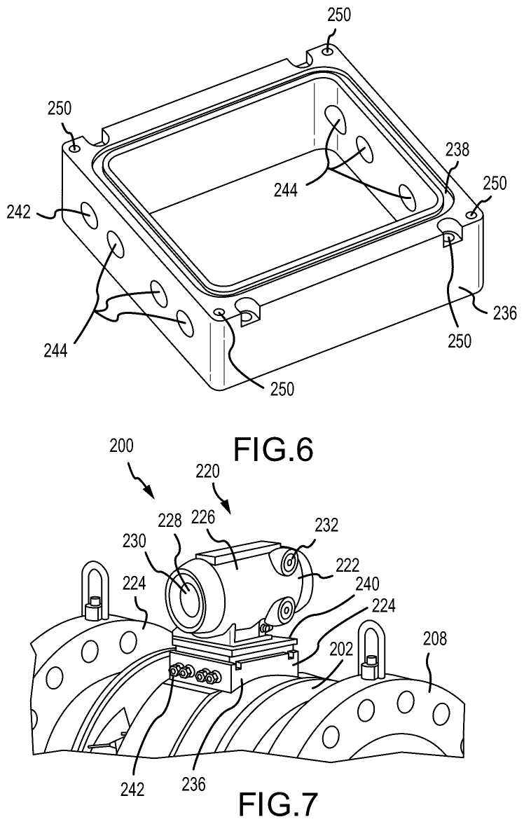

FIG. 6 illustrates an enclosure form 236 used to define an acquisition section enclosure to sealedly enclose and protect the acquisition module 234. The enclosure form 236 can be machined, cast, and/or additively manufactured. The enclosure form 236 may comprise one or more channels 238 that accept seals, such as gaskets or O-rings, for example. The seals may abut the body 202 and/or a form cover 240. The body is cast and/or machined such as attachment region 237 is defined, and wherein the acquisition module 234 may be attached. The enclosure form 236 may circumscribe the acquisition module 234.

The attachment region may be a relatively flat region of the body 202, configured to be attachable to the acquisition module 234 and/or the enclosure form 236. In an embodiment, the attachment region 237 defines a cavity in which the acquisition module 234 may be installed. In an embodiment, the attachment region 237 defines a space wherein a seal may be seated to seal the enclosure form 236 and/or the acquisition module 234 to the body 202.

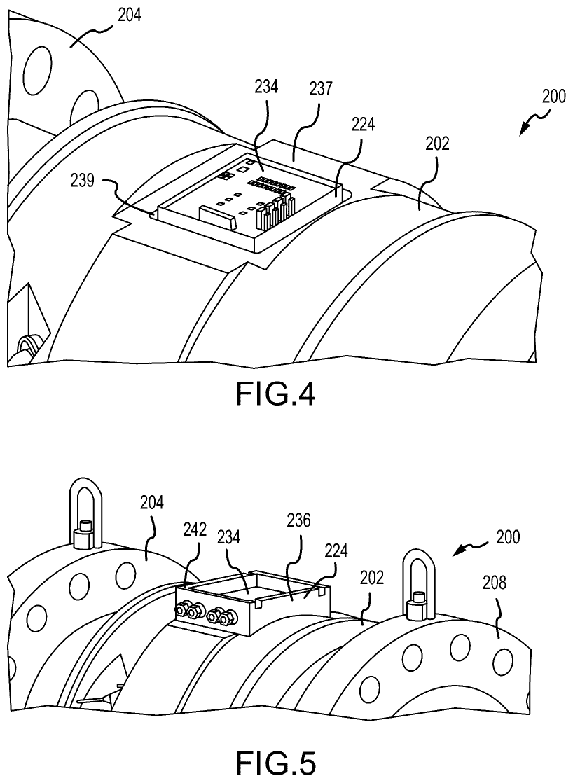

The form cover 240 provides a seal to the acquisition section 224 from the outside environment and also provides a mounting location for the interface section 222. In an embodiment, the interface section 222 is attached directly to the enclosure form 236. The interface section 222 is attached to the form cover 240 with mechanical fasteners. Points that accept mechanical fasteners are shown as element 250. Additionally, the enclosure form 236 comprises cable glands 242 (FIGS. 5 and 7) for routing transducer cables (not shown) to the transducers. The cable glands 242 are installed in holes 244 defined by the enclosure form 236. In an embodiment, a cable shroud 246 may be installed over or near the acquisition section 224 and provides a reduced profile to allow cables to be fully contained and protected under the cable shroud 246 and also provides a more aesthetically pleasing appearance. The shroud is coupled to at least one of the body 202 and the enclosure form 236.

It should be noted that wherever a mechanical fastener is described, it is conceived that in alternate embodiments welding, brazing, adhesives, and other attachment means known in the art may be employed.

The detailed descriptions of the above embodiments are not exhaustive descriptions of all embodiments contemplated by the inventors to be within the scope of the present description. Indeed, persons skilled in the art will recognize that certain elements of the above-described embodiments may variously be combined or eliminated to create further embodiments, and such further embodiments fall within the scope and teachings of the present description. It will also be apparent to those of ordinary skill in the art that the above-described embodiments may be combined in whole or in part to create additional embodiments within the scope and teachings of the present description.

Thus, although specific embodiments are described herein for illustrative purposes, various equivalent modifications are possible within the scope of the present description, as those skilled in the relevant art will recognize. The teachings provided herein can be applied to other sensors, sensor brackets, and conduits and not just to the embodiments described above and shown in the accompanying figures. Accordingly, the scope of the embodiments described above should be determined from the following claims.

What is claimed is:

1. A sonic- or ultrasonic flowmeter (200), comprising:
a body (202) comprising a machined cylindrically hollow bore passing through the body, configured to be connected to a pipeline and operable to have a fluid flow through the bore;
a first connector (204) located on a first end (206) of said body (202) and a second connector (208) located on a second end (210) of said body (202);
meter electronics (220) comprising an interface section smaller than and attachable to the body, the meter electronics configured to interface with sensors (235) and to indicate the degree of fluid flow through the pipeline to which the flowmeter (200) is connected based on signals received from the sensors (235), wherein the meter electronics (220) comprises an acquisition section (224) and the interface section (222);
an acquisition module (234) of the acquisition section (224), configured to communicate with the sensors (235);
an external flat region defined by the body (202) and a recess formed in the flat region, wherein the acquisition module (234) is mounted in the recess;
an enclosure form (236) directly and sealedly attached to the body (202) that circumscribes the acquisition module (234);
interface electronics (232) of the interface section (222) housed in an upper enclosure (226), wherein the upper enclosure (226) is coupled to the enclosure form (236).

2. The sonic- or ultrasonic flowmeter (200) of claim 1, wherein a form cover (240) is coupled to the enclosure form (236) and provides a seal to the acquisition section (224) from the outside environment.

3. The sonic- or ultrasonic flowmeter (200) of claim 2, wherein the form cover (240) defines a mounting location for the upper enclosure (226).

4. The sonic- or ultrasonic flowmeter (200) of claim 1, wherein the upper enclosure (226) comprises a display (230).

5. The sonic- or ultrasonic flowmeter (200) of claim 1, wherein a shroud (246) that encases the acquisition section (224) is directly attached to the body (202) of the flowmeter (200).

6. The sonic- or ultrasonic flowmeter (200) of claim 1, wherein the enclosure form (236) comprises at least one hole (244), and wherein a cable gland (242) is installed in the at least one hole (244).

7. A method for assembling a sonic- or ultrasonic flowmeter (200), comprising:
providing a body (202) comprising a machined cylindrically hollow bore passing through the body, configured to be connected to a pipeline, and operable to have a fluid flow through the bore;
attaching a first connector (204) located on a first end (206) of said body (202) and attaching a second connector (208) located on a second end (210) of said body (202);
interfacing meter electronics (220) with sensors (235), wherein an interface section of the meter electronics is smaller than and attachable to the body;
indicating, with the meter electronics (220), the degree of fluid flow through the pipeline to which the flowmeter (200) is connected based on signals received from the sensors (235), wherein the meter electronics (220) comprises an acquisition section (224) and the interface section (222), and wherein an acquisition module (234) of the acquisition section (224) is configured to communicate with the sensors (235);
defining an external flat region on the body and a recess formed in the flat region;
mounting the acquisition module (234) in the recess;
directly and sealedly attaching an enclosure form (236) to the body (202) that circumscribes the acquisition module (234);
housing interface electronics (232) of the interface section (222) in an upper enclosure (226), wherein the upper enclosure (226) is coupled to the enclosure form (236).

8. The method of claim 7, further comprising the steps of:
coupling a form cover (240) to the enclosure form (236); and
sealing the acquisition section (224) from the outside environment.

9. The method of claim 7, further comprising the step of defining a mounting location for the upper enclosure (226) with the form cover (240).

10. The method of claim 7, wherein the upper enclosure (226) comprises a display (230).

11. The method of claim 7, further comprising the steps of:
attaching a shroud (246) directly to the body (202); and
encasing the acquisition section (224) with the shroud (246).

12. The method of claim 7, wherein the enclosure form (236) comprises at least one hole (244); and
installing a cable gland (242) in the at least one hole (244).
